(19) United States
(12) Patent Application Publication
(10) Pub. No.: US 2024/0092640 A1
(43) Pub. Date: Mar. 21, 2024

(54) LITHIUM FERROMANGANESE PHOSPHATE COMPOSITE MATERIAL AND PREPARATION THEREOF

(71) Applicants: Robert Brian Huang, Las Vegas, NV (US); Richard Brian Huang, Las Vegas, NV (US)

(72) Inventors: Robert Brian Huang, Las Vegas, NV (US); Richard Brian Huang, Las Vegas, NV (US)

(73) Assignee: Watix Technology LLC, Las Vegas, NV (US)

(21) Appl. No.: 17/948,331

(22) Filed: Sep. 20, 2022

(51) Int. Cl. C01B 25/30

(52) U.S. Cl. CPC C01B 25/306

(57) ABSTRACT

The invention discloses a lithium ferromanganese phosphate composite material and a preparation method thereof. The lithium ferromanganese phosphate composite material prepared comprises lithium ferromanganese phosphate material, additive carbon, and a hydrophobic material coating on the surface of the lithium ferromanganese phosphate. Since the hydrophobic material is coated on the surface of lithium ferromanganese phosphate, the lithium ferromanganese phosphate is insulated from outside moisture. Therefore, compared to traditional lithium ferromanganese phosphate material, this lithium ferromanganese phosphate composite material does not easily absorb water within a lithium ferromanganese phosphate battery.

### TECHNICAL FIELD

The present invention concerns the field of chemical technology, in particular to the materials of lithium-ion batteries, in particular to the material of lithium ferromanganese phosphate and a method of preparing the cathode composite material of lithium ferromanganese phosphate.

### BACKGROUND

Lithium-ion batteries are a relatively new technology for the storage of energy, providing high capacity, high voltage, high power, long life cycle, high performance, thermally stable batteries that have found common use in mobile phones, notebook computers, digital cameras, camcorders, and other electronic instruments. The technology has also been used in UPS, electric tools, electric bicycles, electric vehicles, grid energy storage, and other emerging energy-demanding fields. In recent years, the production, technology, and performance of lithium ion batteries has grown exponentially, and it has become even more widely used. At present, lithium ion batteries have become increasingly mature in the fields of both small batteries for portable electronic products, and medium to large batteries for large capacity, high power and large energy storage needs.

The choice of cathode material is important in the construction of lithium ion batteries, as the performance of the batteries largely depend on the chemical properties of the chosen cathode. Consequently, cathode material research is integral to lithium ion battery development. There are currently many kinds of cathode materials for lithium-ion batteries, the most common of which include lithium cobalt oxide, lithium manganese oxide, lithium nickel-cobalt-manganese, and lithium iron phosphate. Lithium cobalt oxide is the most mature of the existing cathode electrode materials and it is mainly used in the field of small batteries, such as mobile phones and digital products. However, disadvantages of the battery include its low cost efficiency (as a result of the high price of cobalt and nickel as raw materials), large environmental impact (as a result of the heavy pollution during mining of the raw materials and during the battery's production), and low safety (as a result of its low thermal stability). Relatively speaking, lithium-ion batteries with lithium manganese oxide, lithium nickel-cobalt-manganese and lithium iron phosphate as cathode materials have better safety performance and better cost efficiency. As such, current industries are mainly focused on these materials. Among them, lithium iron phosphate is distinct by having an extremely long cycle life and the best dollar to kilowatt-hour of storage.

An emerging new cathode material, lithium ferromanganese phosphate, when compared with lithium iron phosphate, can provide better overall performance. The theoretical capacity of lithium ferromanganese phosphate is comparable to that of lithium iron phosphate (˜160-180 mAh/g). However, its Li+/Li electrode potential is much higher (4.1V vs. 3.4V), which allows the battery to have higher energy density when compared to that of lithium iron phosphate. For instance, if the actual capacity of the battery with a lithium ferromanganese phosphate cathode is the same as one with the lithium iron phosphate cathode, its energy density will be 35% higher. Furthermore, when compared to lithium-manganese oxide, which has the same voltage as lithium ferromanganese phosphate, the latter's energy density will be 20% higher due to its more efficient electrochemical structure. Similarly, this structure also grants the lithium ferromanganese phosphate better thermal and electrochemical stability when compared to other cathode types. Finally, lithium ferromanganese phosphate is also more cost efficient (as the overall raw material cost is lower) and more friendly to the environment.

Current developments of lithium ferromanganese phosphate and lithium iron phosphate have had difficulties with a too low specific surface area (thereby decreasing conductivity), a tendency to absorb water, and an overall too complex method of making the battery (which restricts large-scale applications in the field of power and energy storage).

### SUMMARY

The purpose of the present disclosure is to provide a lithium ferromanganese phosphate composite material and a preparation method thereof to solve the technical problems in the prior art, such as easy water absorption and difficult processes in the method of making its batteries.

The technical details of the disclosure are described as follows.

A method for preparing a lithium ferromanganese phosphate composite material, comprising:
(S1) Weighing a lithium source, iron source, manganese source and phosphorus source according to the stoichiometric ratio of each element in LiMnₓFe₁₋ₓPO₄, whereby 0.1≤X≤0.9, followed by ball-milling the raw material in a solvent medium, pre-calcining in an inert atmosphere, and cooling to obtain the precursor material;
(S2) adding the precursor material of S1 with a carbon source, ball-milling the mixed material, drying, and calcining again in an inert atmosphere to obtain the lithium ferromanganese phosphate;
(S3) stirring the lithium ferromanganese phosphate product of step S2 in a solution with dissolved hydrophobic material, drying, and calcining for a third time to obtain the lithium ferromanganese phosphate material composite material. The described lithium ferromanganese phosphate composite material comprises the lithium ferromanganese phosphate material and the carbon and hydrophobic material coating.

Preferably, the molar ratio of the iron element and phosphorus element in the lithium ferromanganese phosphate composite material is Fe:P=0.9˜1.1.

Preferably, the lithium source is one of or a combination of lithium carbonate, lithium hydroxide, and lithium acetate; the iron source is one of or a combination of iron oxalate, iron phosphate, and iron nitrate; the manganese source is one of or a combination of manganese acetate, manganese oxalate, and manganese carbonate; the phosphorus source is one of or a combination of ammonium dihydrogen phosphate, diammonium hydrogen phosphate, and ammonium phosphate; the carbon source is one of or a combination of glucose, PEG (polyethylene glycol), PVA (polyvinyl alcohol), or sucrose.

Preferably, in step S1 and S2 the solvent medium of the primary and secondary ball milling is acetone, ethanol or deionized water, and the milling time is 2 h˜12 h.

Preferably, the temperature and duration of the pre-calcining is 300˜500° C. for 0.5 h˜10 h; of the secondary calcination is 500˜800° C. for 0.5 h˜6 h; of the tertiary calcinations is 300˜500° C. for 0.5 h˜10 h.

Preferably, the atmosphere for the primary, secondary and tertiary calcination is argon or nitrogen.

Preferably, the hydrophobic material is a polyurethane.

Preferably, the mass of the described hydrophobic material is 0.5% to 5% of the mass of the lithium ferromanganese phosphate material.

Preferably, the drying method of step S2 is spray drying or plough shear mixing drying, and the spray drying temperature is 80° C.˜300° C.

Preferably, the cooling method of step S1 is natural cooling at room temperature.

Secondly, the lithium ferromanganese phosphate composite material prepared by the aforementioned method.

Thirdly, a cathode electrode constructed from the aforementioned lithium ferromanganese phosphate composite material.

The lithium ferromanganese phosphate composite material prepared comprises lithium ferromanganese phosphate material, additive carbon, and the hydrophobic material coating on the surface of the lithium ferromanganese phosphate. Since the hydrophobic material is coated on the surface of lithium ferromanganese phosphate, the lithium ferromanganese phosphate is insulated from outside moisture. Therefore, compared to traditional lithium ferromanganese phosphate material, this lithium ferromanganese phosphate composite material does not easily absorb water within a lithium ferromanganese phosphate battery.

In addition, the whole preparation process of this lithium ferromanganese phosphate composite material is far more simple to operate and scale to industrial production.

### BRIEF DESCRIPTION OF THE DRAWINGS

FIG. 1 is a flow chart of the preparation method of the lithium ferromanganese phosphate composite material in one embodiment.

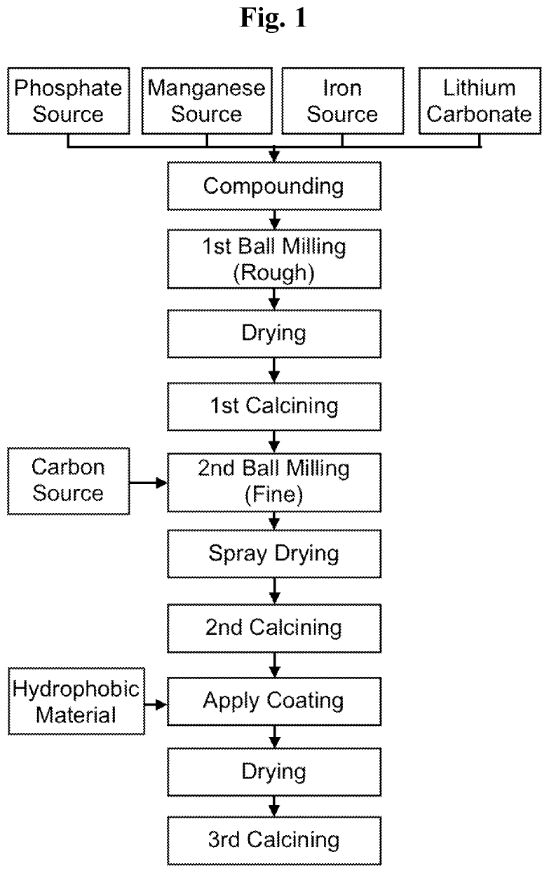

FIG. 2 features 3 charts and 1 table that illustrate the charge and discharge characteristics of a half-cell coin battery that uses a lithium ferromanganese phosphate cathode prepared according to embodiment 1 of the present invention. The (a) graph, (b) graph, and (c) graph illustrate the charge and discharge curves of a half-cell constructed from a lithium ferromanganese phosphate cathode prepared according to embodiment 1 of the present invention. The (d) table displays various electrochemical properties of a half-cell constructed from a lithium ferromanganese phosphate cathode prepared according to embodiment 1 of the present invention. The first column describes the first cycle efficiency of the half-cell. The second column indicates the capacity of the battery after the first charge. The remaining columns indicate the discharge capacity of the battery at various charge rates.

FIG. 3 features 3 charts and 1 table that illustrate the charge and discharge characteristics of a half-cell coin battery that uses a lithium ferromanganese phosphate cathode prepared according to embodiment 2 of the present invention. The marked (a) graph, (b) graph, and (c) graph illustrate the charge and discharge curves of a half-cell constructed from a lithium ferromanganese phosphate cathode prepared according to embodiment 2 of the present invention. The (d) table displays various electrochemical properties of a half-cell constructed from a lithium ferromanganese phosphate cathode prepared according to embodiment 2 of the present invention. The first column describes the first cycle efficiency of the half-cell. The second column indicates the capacity of the battery after the first charge. The remaining columns indicate the discharge capacity of the battery at various charge rates.

### DETAILED DESCRIPTION OF EMBODIMENTS

In order to promote the understanding of the present disclosure, the disclosure will be described below in detail, with reference to the preferred embodiments. It should be understood that the embodiments are merely illustrative, and are not intended to limit the scope of the present disclosure. Any changes, modifications and replacements made by those skilled in the art without departing from the spirit of the disclosure should fall within the scope of the disclosure defined by the appended claims.

The instruments used in the following embodiments include: a sanding machine (model SX-200, manufactured by Wuxi Xiguang Powder Technology Co., LTD); a spray dryer (model LP-12, manufactured by Shanghai Gaoling Technology Development Co., LTD); a tube box furnace (model OTL1200-11, manufactured by Anhui Hefei Hengli Electronic Equipment Company); an air box furnace (model HXL004-12, manufactured by Anhui Hefei Hengli Electronic Equipment Company).

### Embodiment 1

The present disclosure provides a method for preparing a lithium ferromanganese phosphate composite material, which is described as follows:

(S1) Weigh 32.95 g lithium carbonate, 98.04 g manganese acetate, 90.45 g anhydrous iron phosphate, and 115.03 g ammonium dihydrogen phosphate and add them with 500 ml ethanol to a high-speed ball milling machine. Mill for 2 hours. Dry the mixed slurry in a blast drying oven at 400° C. for 5 hours in a nitrogen atmosphere. Obtain the precursor material after cooling to room temperature.

(S2) Add 6.73 g glucose and 500 mL ethanol to the obtained precursor from step S1 and mill the mixture in the high-speed ball milling machine for 3 hours. Dry the obtained slurry in a spray drying machine at an inlet temperature of 110° C. and an outlet temperature of 230° C. Calcinate the material at 750° C. for 3 hours in a nitrogen atmosphere to obtain the lithium ferromanganese phosphate LiMn_{0.4}Fe_{0.6}PO₄ material.

(S3) Stir the lithium ferromanganese phosphate from step S2 in an 500 mL acetone solution with 8.01 g polyurethane material. Dry the material in an air drying oven. Calcinate the material at 500° C. for 5 hours in a nitrogen atmosphere to obtain the lithium ferromanganese phosphate LiMn_{0.4}Fe_{0.6}PO₄ composite material.

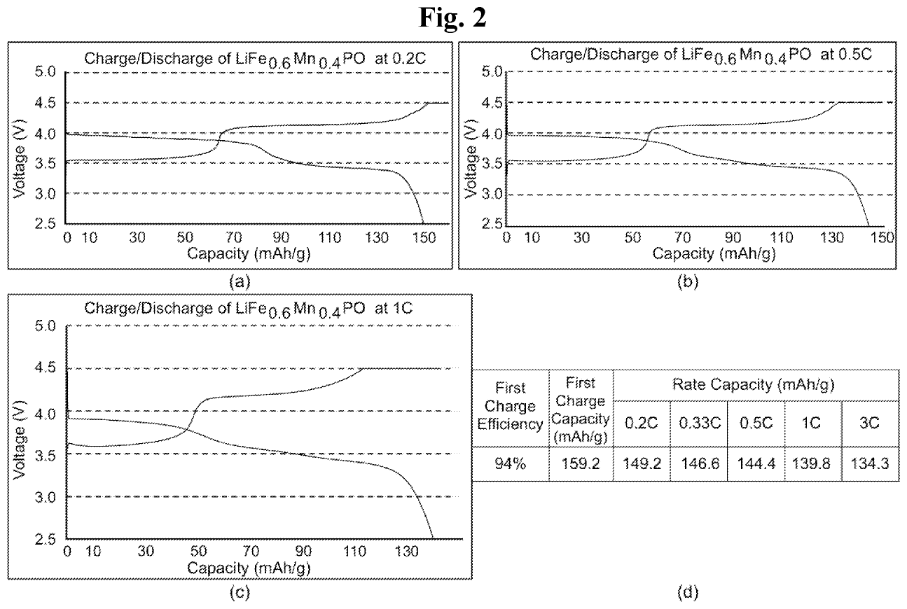

The discharge specific capacities of the lithium iron phosphate cathode prepared by this example, according to FIG. 2, are 149.2 mAh/g and 139.8 mAh/g at 0.2 C and 1 C respectively. Furthermore, the first cycle efficiency is 94% at 0.2 C. The lithium ferromanganese phosphate composite material cathode prepared therefore has high specific capacity, good conductivity, and excellent rate-ability performance.

### Embodiment 2

The present disclosure provides a method for preparing a lithium ferromanganese phosphate composite material, which is described as follows.

(S1) Weigh 41.95 g lithium hydroxide monohydrate, 63.02 g manganese oxalate, 75.41 g iron phosphate, and 132.05 g diammonium hydrogen phosphate and add them with 500 ml acetone to a high-speed ball milling machine. Mill for 3 hours. Dry the mixed slurry in a blast drying oven at 450° C. for 4 hours in a nitrogen atmosphere. Obtain the precursor material after cooling to room temperature.

(S2) Add 4.23 g glucose and 500 mL acetone to the obtained precursor from step S1 and mill the mixture in the high-speed ball milling machine for 4 hours. Dry the obtained slurry in a spray drying machine at an inlet temperature of 125° C. and an outlet temperature of 280° C. Calcinate the material at 700° C. for 4 hours in a nitrogen atmosphere to obtain the lithium ferromanganese phosphate LiMn_{0.4}Fe_{0.6}PO₄ material.

(S3) Stir the lithium ferromanganese phosphate from step S2 in an 500 mL acetone solution with 6.82 g polyurethane material. Dry the material in an air drying oven. Calcinate the material at 450° C. for 6 hours in a nitrogen atmosphere to obtain the lithium ferromanganese phosphate LiMn_{0.4}Fe_{0.6}PO₄ composite material.

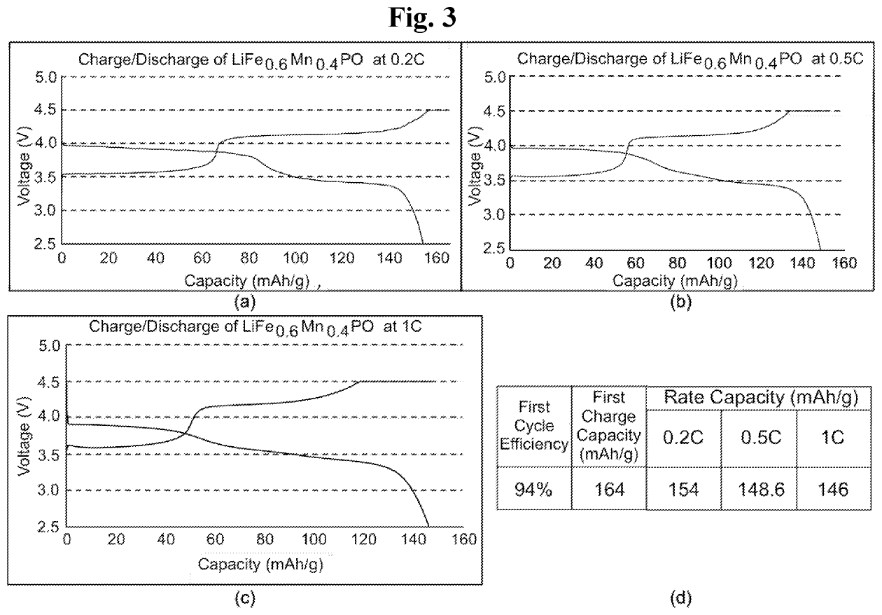

The discharge specific capacities of the lithium iron phosphate cathode prepared by this example, according to FIG. 3, are 154 mAh/g and 146 mAh/g at 0.2 C and 1 C respectively. Furthermore, the first cycle efficiency is 94% at 0.2 C. The lithium ferromanganese phosphate composite material cathode prepared therefore has high specific capacity, good conductivity, and excellent rate-ability performance.

### Embodiment Moisture Comparison Test:

The lithium ferromanganese phosphate material without hydrophobic material coating (sample A) was obtained immediately following step S2 in embodiment 1. The lithium ferromanganese phosphate composite material (sample B) was obtained immediately following step S3 in embodiment 1. Sample A and sample B were independently dried at 600° C. for 8 hours in a nitrogen atmosphere. After cooling them to room temperature, a coulometer was used to measure the moisture of the two samples. The initial moisture levels of sample A and sample B were 81 ppm and 78 ppm respectively. Sample A and sample B were then left at room temperature for 48 hours, after which their moistures were measured again. The final moisture levels of sample A and sample B were 1300 ppm and 138 ppm respectively, indicating that the hydrophobic coating within the lithium ferromanganese phosphate composite material prevented water absorption.

1. A method for preparing a lithium ferromanganese phosphate composite material characterized by the following steps:
(S1) Weighing a lithium source, iron source, manganese source and phosphorus source according to the stoichiometric ratio of each element in LiMnₓFe₁₋ₓPO₄, whereby 0.1≤X≤0.9, followed by ball-milling the raw material in a solvent medium, pre-calcining, and cooling to obtain the precursor material;
(S2) adding the precursor material of S1 with a carbon source, ball-milling the mixed material, drying, and calcining again in an inert atmosphere to obtain the lithium ferromanganese phosphate;
(S3) stirring the lithium ferromanganese phosphate product of step S2 in a solution with dissolved hydrophobic material, drying, and calcining for a third time to obtain the lithium ferromanganese phosphate material composite material. The described lithium ferromanganese phosphate composite material comprises the lithium ferromanganese phosphate material and the carbon and hydrophobic material coating.

2. The method for preparing lithium ferromanganese phosphate composite material of claim 1, wherein the molar ratio of iron and phosphorus in the lithium ferromanganese phosphate composite material is Fe:P=0.9˜1.1.

3. The method for preparing lithium ferromanganese phosphate composite material of claim 1, wherein the lithium source is one of or a combination of lithium carbonate, lithium hydroxide, and lithium acetate; the iron source is one of or a combination of iron oxalate, iron phosphate, and iron nitrate; the manganese source is one of or a combination of manganese acetate, manganese oxalate, and manganese carbonate; the phosphorus source is one of or a combination of ammonium dihydrogen phosphate, diammonium hydrogen phosphate, and ammonium phosphate; the carbon source is one of or a combination of glucose, PEG (polyethylene glycol), PVA (polyvinyl alcohol), or sucrose.

4. The method for preparing lithium ferromanganese phosphate composite material of claim 1, wherein in step S1 and S2 the solvent medium of the primary and secondary ball milling is acetone, ethanol or deionized water, and the milling time is 2 h˜12 h.

5. The method for preparing lithium ferromanganese phosphate composite material of claim 1, wherein the temperature and duration of the pre-calcining is 300˜500° C. for 0.5 h˜10 h; of the secondary calcination is 500˜800° C. for 0.5 h˜6 h; of the tertiary calcination is 300˜500° C. for 0.5 h˜10 h.

6. The method for preparing lithium ferromanganese phosphate composite material of claim 1, wherein the atmosphere for the primary, secondary and tertiary calcinations is argon or nitrogen.

7. The method for preparing lithium ferromanganese phosphate composite material of claim 1, wherein the hydrophobic material is a polyurethane.

8. The method for preparing lithium ferromanganese phosphate composite material of claim 1, wherein the mass of the described hydrophobic material is 0.5% to 5% of the mass of the lithium ferromanganese phosphate material.

9. A lithium ferromanganese phosphate composite material prepared by the method described in any one of the claims 1-8.

10. A cathode electrode sheet prepared from the lithium ferromanganese phosphate composite material prepared by the method described in any one of the claims 1-8.
